(19) United States
(12) Patent Application Publication
(10) Pub. No.: US 2014/0116940 A1
(43) Pub. Date: May 1, 2014

(54) REMOVAL OF ELEMENTS FROM AQUEOUS FLUIDS

(71) Applicant: The Water Company, Pueblo, CO (US)

(72) Inventors: Brian B. ELSON, Pueblo, CO (US); Michael Fallbach, Woodland Park, CO (US)

(73) Assignee: The Water Company, Pueblo, CO (US)

(21) Appl. No.: 14/061,546

(22) Filed: Oct. 23, 2013

Related U.S. Application Data
(60) Provisional application No. 61/718,237, filed on Oct. 25, 2012.

(51) Int. Cl. C02F 1/42; C02F 1/461; C02F 1/66

(52) U.S. Cl. CPC C02F 1/42; C02F 1/66; C02F 1/461
USPC 210/635; 210/683; 210/684

(57) ABSTRACT

Methods of removing ions from an aqueous fluid can comprise increasing the pH of the aqueous fluid and contacting the aqueous fluid with anion exchange materials.

### BACKGROUND

Treating aqueous fluids, such as water from mining operations, ground water, waste streams, and the like, can involve removal of one or more elements from the aqueous fluid, such as one or more transition metals, one or more heavy metals, one or more lanthanides, and one or more actinides. In a mining operation, recovery of one or more of these elements from solution can be essential to economic success. In both mining and waste water treatment, removal of the one or more elements is often required by law, statute, or regulation, for use or disposal of the aqueous fluid.

The one or more elements can be present in the aqueous fluid in the form of positively charged ions, or one or more negatively charged complexes that comprise the one or more elements. For example, chromium can be present as a chromate anion, CrO₄²⁻, a dichromate anion Cr₂O₇²⁻, or a as chromium carbonate, Cr(CO₃)²⁻, iron can be present as Fe(OH)₄²⁻, lead can be present as Pb(OH)₃⁻, uranium can be present as uranyl carbonate, UO₂(CO₃)₂²⁻, arsenic can be present as dihydrogen arsenate, H₂AsO₄, hydrogen arsenate, HAsO₄²⁻, or arsenate AsO₄³⁻. Other negatively charged complexes of these and other elements can also exist, depending on the contents of the aqueous fluid.

In principle, the one or more negatively charged complexes can be removed from the aqueous fluid by passing the aqueous fluid through one or more anion exchange materials, such as one or more anion exchange resins. In practice, however, the use of anion exchange resins can be problematic because the anion exchange resins can become “saturated” during use, at which point they are unable to remove additional amounts of negatively charged complexes. Upon saturation, the aqueous fluid passing through the one or more anion exchange resins can contain unacceptably high levels of these negatively charged complexes. The negatively charged complexes are said to “break through” the anion exchange resins when the level of the negatively charged complexes in the aqueous fluid is too high after the aqueous fluid has passed through the anion exchange resins. The volume of aqueous fluid that can be treated by a particular anion exchange resin (or mixture of anion exchange resins) before break through is sometimes referred to as the “break through volume.”

Break through is a problem because the anion exchange resin must be regenerated or replaced in order to continue removing the negatively charged complexes from the aqueous fluid. The need to frequently regenerate or replace the one or more anion exchange resin can lead to a less efficient operation, for example, if the process must be halted while the anion exchange resin is replaced or regenerated. Also, the need to replace or regenerate the anion exchange resin can result in higher material and process costs. Further, when a valuable element is recovered by the anion exchange resin it would be desirable to increase the amount of such elements recovered per unit volume of the anion exchange resin, in order to increase the overall efficiency and profitability of the process.

### BRIEF DESCRIPTION OF THE FIGURES

FIG. 1 is a drawing of an exemplary electrolyzing chamber for increasing the pH of an aqueous fluid;

FIG. 2 is a graph of uranium concentration versus ion exchange bed volumes.

### SUMMARY OF THE INVENTION

In one embodiment, the present invention is directed to a method of removing one or more elements from an aqueous fluid comprising increasing the pH of the aqueous fluid to about 9 or greater, thereby forming one or more negatively charged complexes comprising the one or more elements; and contacting the aqueous fluid with one or more anion exchange materials, thereby binding the one or more negatively charged complexes to the anion exchange material.

Increasing the pH of the aqueous fluid can be carried out, for example, by adding one or more bases or by electrolysis.

In another embodiment, the one or more elements removed from the aqueous fluid comprise uranium.

In another embodiment, the anion exchange material comprises an anion exchange resin.

In a particular embodiment, the anion exchange resin comprises cross-linked, quaternary ammonium functional polystyrene.

### DETAILED DESCRIPTION

All documents (e.g. patents, patent applications, publications, etc.) cited herein are incorporated by reference in their entirety for all purposes.

In various embodiments, the present invention is directed to a method of removing one or more elements from an aqueous fluid. The method can comprise increasing the pH of the aqueous fluid to form one or more negatively charged complexes of the one or more elements, and contacting the resulting pH adjusted aqueous fluid with an anion exchange material, to immobilize the one or more negatively charged complexes on the anion exchange resin.

The one or more anion exchange materials of the present invention can include a single type of anion exchange material or a combination of two or more anion exchange materials. The one or more anion exchange materials can be one or more organic anion exchange materials such as anion exchange resins, or inorganic anion exchange materials such as modified zeolites, metal oxides, etc. Organic anion exchange materials can include any anion exchange resins known in the art for exchanging one or more anions. For example, anion exchange resins can be in the form of polymeric beads, such as a gel, and can comprise one or more anion exchange polymers, for example polymers with strongly basic functional group, such as quaternary ammonium functional groups.

Nonlimiting examples of such anion exchange polymers include functionalized polystyrene, such as polystyrene functionalized with quaternary ammonium functional groups, such as trialkyl ammonium groups (e.g. trimethyl ammonium groups), polyethylene polymers, functionalized polyacrylamides such as poly(acrylamido-N-propyltrimethylammonium chloride) (polyAPTAC), or poly quaternium polymers. The anion exchange polymers can also be crosslinked with a crosslinker, for example a divinyl compound such as divinyl benzene. The exchange resin can comprise a polystyrene gel that is functionalized with quaternary ammonium functional groups and cross-linked with divinyl benzene. Such anion exchange resins are commercially available, and are currently sold under trade names such as DOWEX 21, DOWEX 21K 16/20, DOWEX 1, DOWEX 21K 16/30, and DOWEX 21K XLT (DOWEX is a registered trademark of the Dow Chemical Company).

The pH of the aqueous fluid can be increased by any suitable method or methods. For example, the pH can be increased by one or more of contacting the aqueous fluid with one or more bases, and electrolyzing the aqueous fluid. When increasing the pH comprises contacting aqueous fluid with one or more bases, the one or more bases can be, for example, one or more of solid base, a basic solution, or a basic suspension. Nonlimiting examples of suitable bases include hydroxide salts, for example, one or more of alkali metal hydroxides or oxides, alkaline earth hydroxides or oxides, transition metal hydroxides or oxides, etc. Suitable hydroxides include sodium hydroxide, potassium hydroxide, ammonium hydroxide, and magnesium hydroxide (or mixtures thereof). Solutions and/or suspensions containing one or more of the above-mentioned hydroxide or oxide compounds can also be used. Bases that react with the contents of the aqueous fluid to form insoluble materials are sometimes avoided if the insoluble materials clog the anion exchange resin. However, if the insoluble materials do not clog the anion exchange resin, or if they are removed from the aqueous fluid before contacting the aqueous fluid with the anion exchange resin, then formation of insoluble materials is not problematic.

The one or more bases can be added to the aqueous fluid in one or more mixing chambers. Mixing chambers can include appropriately sized mixing vessels, or alternatively could include settlement ponds or other enclosures suitable for containing the aqueous fluid, and which can be fitted with suitable mixing elements as described herein. Other process steps in addition to adding the one or more bases can also take place in the one or more mixing chambers. The one or more mixing chambers can comprise one or more mixing elements for mixing the base with the aqueous fluid. When the base comprises a solid, mixing with the one or more mixing elements can dissolve all or part of the solid base in the aqueous fluid, although this is not required unless otherwise specified. The one or more mixing elements can include one or more of paddle mixers, impellers, such as mixed flow impellers, turbine mixers, such as curved blade turbines, and radial blade turbines, vortex mixers, agitators, such as gear driven agitators, drum mixers, and stirrers.

Increasing the pH of the aqueous fluid can be effected by electrolyzing the aqueous fluid. Electrolyzing the aqueous fluid can comprise electrolyzing with one or more electrodes, and can take place within one or more electrolyzing chambers. The one or more electrolyzing chambers can be any location where electrolyzing takes place; other process steps in addition to electrolyzing can also take place within the one or more electrolyzing chambers.

The one or more electrodes can comprise one or more electrosorptive electrodes, which can be disposed inside the one or more electrolyzing chambers such that they are in contact with the aqueous fluid. The one or more electrosorptive electrodes can comprise one or more of an anode and a cathode. As an example, one or more anodes can comprise electrosorptive electrodes and one or more cathodes can comprise non-electrosorptive electrodes; one or more anodes can comprise non-electrosorptive electrodes and one or more cathodes can comprise electrosorptive electrodes, or both one or more anodes and one or more cathodes can comprise electrosorptive electrodes. Typically, one or more anodes comprise electrosorptive electrodes, and one or more cathodes comprise non-electrosorptive electrodes, although this is not required unless otherwise specified.

Electrosorptive electrodes can be porous, and can contain one or more electrosorptive materials. The one or more electrosorptive materials can include, for example, one or more conductive carbon materials, such as one or more of activated carbon, carbon aerogel, reticulated vitreous carbon, and pyrrolized resorcinol formaldehyde resin, one or more metal carbides, such as one or more of TiC, ZrC, VC, NbC, TaC, UC, MoC, WC, MO₂C, Cr₃C, and Ta₂C, one or more metals such as Cu, Ag, Fe, Ni, Au, Al, Ni, Pt, and Zn, and one or more steel material, such as stainless steel. The electrosorptive material can be surface modified, for example, by surfactant adsorption. The electrosorptive material can be in any suitable form, for example, one or more of granules, powders, sheets, and porous monoliths.

When the one or more electrosorptive materials comprise one or more granules or powders, the one or more granules or powders can be arranged in a layer between one or more porous members and one or more substrates. The one or more porous members can have a pore size that is smaller than the particle size of the one or more granules or powders. One or more compression elements, such as an inflatable bladder, pump, press, or the like, can be associated with the one or more electrosorptive electrodes for maintaining a pressure on the porous member or the substrate and for retaining the one or more granules or powders between the porous member and the substrate. In this arrangement, no binder or glue for affixing the one or more electrosorptive granules or powders to the substrate is needed. The one or more compression element can also release the pressure on the one or more porous members or the one or more substrates to release the one or more powders or granules. Upon release, the one or more powders or granules can be moved, for example by blowing or application of partial vacuum, to one or more wash chambers where they can be washed with one or more of an acid and a base. After washing, the one or more powders or granules can be moved back in place between the porous member and the substrate. One or more of the one or more electrolyzing chambers can include a plurality electrosorptive electrodes of this type, so that when the granules or powder of electrosorptive material from one electrosorptive electrode are being washed, other electrosorptive electrodes can continue operating and the electrolyzing process can continue without interruption.

Some suitable electrosorptive electrodes and electrolyzing chambers containing electrosorptive electrodes are described in U.S. Pat. No. 5,954,937, which is herein incorporated by reference in its entirety for all purposes, U.S. Pat. Pub. 2009/0045074, which is herein incorporated by reference in its entirety for all purposes, and U.S. Pat. Pub. 2008/0078673, which is herein incorporated by reference in its entirety for all purposes. However, no particular electrodes or electrolyzing chambers are required unless otherwise specified.

When one or more non-electrosorptive electrodes are used, they can be any non-electrosorptive electrodes known in the art. For example, the one or more non-electrosorptive electrodes can comprise one or more non-porous electrode materials, such as stainless steel, iron, titanium, conductive carbon, copper, silver, gold, and platinum.

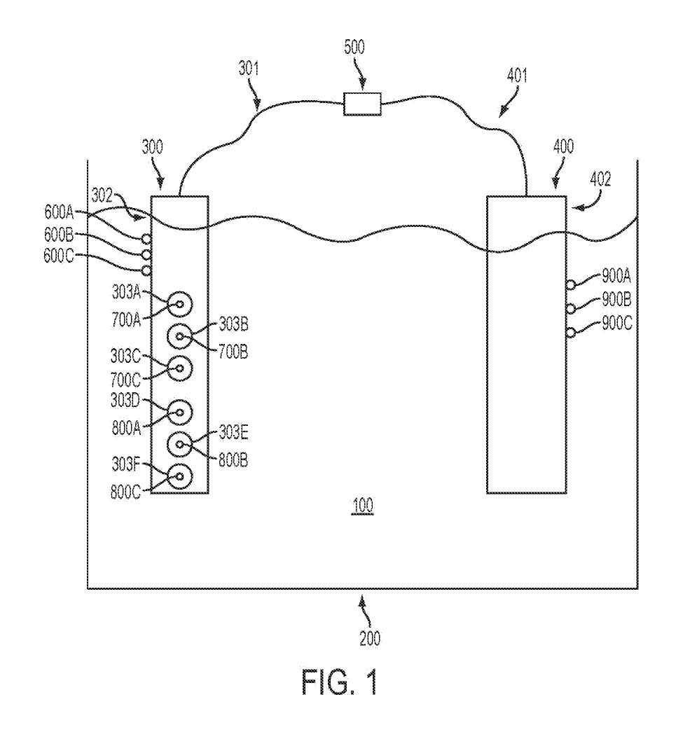

FIG. 1 is a diagram showing an example of increasing the pH of an aqueous fluid 100 by electrolyzing the aqueous fluid 100 that contacts a porous electrosorptive anode 300 and non-porous, non-electrosorptive cathode 400 in electrolyzing chamber 200. The porous electrosorptive anode 300 and non-porous, non-electrosorptive cathode 400 are both electrically connected to power source 500 by, respectively, anode connector 301 and cathode connector 401. The power source 500 provides a potential difference between the porous electrosorptive anode 300 and non-porous, non-electrosorptive cathode 400 across aqueous fluid 100. The potential difference can be sufficient to electrolyze the water in aqueous fluid 100, for example, about 1 V or greater, about 1.5 V or greater, about 1.8 V or greater, about 2 V or greater, or about 2.5 V or greater.

When the potential difference is sufficient to electrolyze water, hydrogen or hydronium ions 600A, 600B, and 600C associated with the porous electrosorptive anode 300 can form on surface 302 of the porous electrosorptive anode 300. At the same time, negative ions 700A, 700B, and 700C, from the aqueous fluid 100 are attracted to the porous electrosorptive anode 300 and accumulate in pores 303A, 303B, and 303C of the porous electrosorptive anode 300. Negative ions 700A, 700B, and 700C can be, for example, one or more of sulfate, bisulfate, chloride, nitrate, phosphate, hydrogen phosphate, dihydrogen phosphate, and carbonate. Acids 800A, 800B, and 800C, which can be any acid but are typically Arrhenius acids such as one or more of H₂SO₄, HCl, HNO₃, H₂CO₃, and H₃PO₄, can be formed inside pores 303D, 303E, and 303F when hydrogen or hydronium ions 600A, 600B, and 600C migrate into the porous structure of the porous electrosorptive anode 300 and react with negative ions 700A, 700B, and 700C. The acids 800A, 800B, and 800C can be captured within the pores 303D, 303E, and 303F of the porous electrosorptive anode 300. When acids 800A, 800B, and 800C are captured within the porous electrosorptive anode 300, they cannot migrate into the aqueous fluid 100.

At the same time, hydroxide ions 900A, 900B, and 900C, which are associated with non-porous, non-electrosorptive cathode 400, can form on surface 402 of the non-porous, non-electrosorptive cathode 400. Because the non-porous, non-electrosorptive cathode 400 is not electrosorptive, the hydroxide ions can migrate into the aqueous fluid 100.

Electrolyzing as described above with reference to FIG. 1 can create equal numbers of hydrogen or hydronium ions 600A, 600B, and 600C and hydroxide ions 900A, 900B, and 900C. The hydrogen or hydronium ions 600A, 600B, and 600C can form acids 700A, 700B, and 700C, which are captured in the porous structure of the porous electrosorptive anode 300, whereas the hydroxide ions 900A, 900B, and 900C can migrate into the aqueous fluid 100. In this way, electrolyzing can provide an excess of hydroxide ions 900A, 900B, and 900C in the aqueous fluid 100, thereby increasing the pH of the aqueous fluid 100.

The aqueous fluid, such as aqueous fluid 100, can be, for example, one or more of water, groundwater, mine drainings, mine tailings, mine dumps, culm dumps, tails, slimes, refuses, leach residue, waste fluid from in situ mining, impregnated fluid from in situ mining, waste fluid from heap mining, impregnated fluid from heap mining, waste fluid from a nuclear facility, such as a nuclear power generation facility or nuclear testing facility, municipal waste water, and gangue-containing aqueous fluid. The aqueous fluid can comprise, in addition to water, one or more liquids other than water, for example, one or more alcohols, such as ethanol, methanol, propanol, isopropanol, etc., glycerol, glycerin, dioxins, acetone, oil, grease, wax, petroleum, kerosene, benzene, toluene, xylene, poly(alkylene oxides), such as liquid poly(ethylene oxide), dissolved poly(ethylene oxide), liquid poly(ethylene glycol), dissolved poly(ethylene glycol), liquid poly(propylene oxide), dissolved poly(propylene oxide), liquid copolymers of ethylene oxide and propylene oxide, and dissolved copolymers of ethylene oxide and propylene oxide, turpentine, liquid surfactants, dissolved surfactants, alkyl acetates, such as ethyl acetate and butyl acetate, methyl ethyl ketone, diethyl ether, tetrahydrofuran, dimethyl sulfoxide, dimethyl formamide, plasticizers, (alk)acrylates, such as poly((meth)acrylate), copolymers of poly((meth)acrylate), poly(methyl(meth)acrylate), and copolymers of one or more poly(methyl(meth)acrylate)s, carbon tetrachloride, and chloroform.

Increasing the pH of the aqueous fluid can comprise increasing the pH to about 9.0 or greater, such as to about 10 or greater, or from about 10 to about 11. Increasing the pH of the aqueous fluid can also comprise increasing the pH to about 9.1, about 9.2, about 9.3, about 9.4, about 9.5, about 9.6, about 9.7, about 9.8, about 9.9, about 10.0, about 10.1, about 10.2, about 10.3, about 10.4, about 10.5, about 10.6, about 10.7, about 10.8, about 10.9, about 11.0, about 11.1, about 11.2, about 11.3, about 11.4, about 11.5, about 11.6, about 11.7, about 11.8, about 11.9, about 12.0, about 12.1, about 12.2, about 12.3, about 12.4, about 12.5, about 12.6, about 12.7, about 12.8, about 12.9, about 13.0, about 13.1, about 13.2, about 13.3, about 13.4, about 13.5, about 13.6, about 13.7, about 13.8, about 13.9, about 14.0, or to one or more ranges defined by any two of the above-mentioned values.

Increasing the pH of the aqueous fluid can result in the formation of one or more negatively charged complexes containing one or more elements. Thus, the one or more negatively charged complexes can comprise one or more elements such as heavy metals, transition metals, lanthanides, actinides, alkali metals, such as alkali metals with d electrons, alkaline earth metals, such as alkaline earth metals with d-electrons, rare earth metals, and semi-metals. For example, the one or more negatively charged complexes can comprise one or more of antimony, arsenic, barium, beryllium, cadmium, chromium, copper, iron, lead, manganese, mercury, such as organic or inorganic mercury, scandium, selenium, silver, thallium, uranium, zinc, nickel, thorium, plutonium, neptunium, americium, and actinium. In addition, the one or more negatively charged complexes can comprise one or more additional species, such as one or more of carbonate, hydrogen carbonate, water, sulfate, sulfite, sulfide, chloride, chlorate, perchlorate, chlorite, hypochlorite, bromide, oxide, hydroxide, ammonium, fluoride, iodate, and iodide, for example, one or more of carbonate and sulfate. When the aqueous fluid is obtained from uranium mining, the negatively charged complex can comprise uranium, for example, in the form of uranyl ions, and one or more of carbonate and sulfate, although no particular elements or additional species are required unless otherwise specified.

After the pH of the aqueous fluid is increased, the aqueous fluid can be allowed to sit for a predetermined amount of time in order to facilitate chemical reactions that form the one or more negatively charged complexes. For example, the aqueous fluid can be allowed to sit for a time from about 15 minutes to about 3 hours, or about fifteen minutes to about 2 hours, or about thirty minutes to about 1.5 hours, or about 1 hour. During this time, the aqueous fluid can be stirred or mixed by one or more mixing elements.

The one or more negatively charged complexes can have a charge of 2− or lower, such as 3− or lower, or 4− or lower, for example, 4−. Such charges allow the negatively charged complex to more effectively bind to the one or more anion exchange materials, such as one or more anion exchange resins, particularly when the aqueous fluid also contains other anions such as sulfate, chloride, bromide, chlorate, etc. that can compete with the negatively charged complex for binding sites on the anion exchange resin. When the negatively charged complexes of interest, such as uranium complexes are more highly charged (i.e., more negatively charged) than other anions present in the aqueous fluid, then the negatively charged complexes of interest can displace the other anions, which can be, for example, one or more of ions with 1− charges, such as bromide, chloride, etc., and ions with 2− charges, such as carbonate, sulfate, etc., on binding sites of the anionic exchange resin.

The nature of the negatively charged complex will depend on the source and nature of the aqueous fluid. As an example, aqueous fluids can come from uranium mining. Uranium mining often involves one or more of in situ leaching, which is sometimes called solution mining or in situ recovery, and heap leaching. In an in situ leaching process, an aqueous extraction liquid is injected into uranium ore, for example with one or more mining injectors known in the art, without removing the ore from the ground. The extraction liquid can be acidified with added sulfuric acid or made alkaline with added carbonate, depending on the nature of the ore and surrounding rock. The acidic or alkaline extraction liquid can dissolve the uranium-containing components of the ore, impregnating the extraction liquid with dissolved uranium. The extraction liquid can then be removed from the ground, for example with one or more mining extractors known in the art. Heap leaching, sometimes known as heap mining, is similar to in situ leaching except that the uranium ore is removed from the ground and placed in a heap above ground before contacting it with the acidic or alkaline extraction liquid.

In heap leaching and in situ leaching, some of the uranium, for example, up to about 80% of the dissolved uranium, or up to about 70% of the dissolved uranium, or up to about 60% of the dissolved uranium, or from about 60% to about 80% of the dissolved uranium, can recovered by adjusting the pH to from about 6 to about 9, for example from about 6 to about 8, which can induce precipitation of some uranium containing salts. These salts can be removed by methods known in the art such as decanting, filtering, or settling. However, even after precipitation, the resulting aqueous fluid can still contain a significant amount of dissolved uranium.

Removing this additional uranium from the aqueous fluid using one or more anion exchange materials (e.g. anion exchange resins) is challenging because the aqueous fluid can have a high concentration of ions which interferes with the efficiency of the binding of the desired uranium ion(s) with the anion exchange material. For example, when an acidic extraction liquid is used, the aqueous fluid can have a sulfate ion concentration of about 100 mg/L or more, or from about 100 mg/L to about 2,000 mg/L. Similarly, when an alkaline extraction liquid is used, the aqueous fluid can have a carbonate ion concentration of about 100 mg/L or more, or from about 100 mg/L to about 2,000 mg/L. In other cases, such as when an alkaline extraction liquid is used in conjunction with a sulfate-containing ore, the aqueous fluid can have a concentration of both sulfate and carbonate that are, for example, about 100 mg/L or more, or from about 100 mg/L to about 2,000 mg/L.

When the pH of the aqueous fluid is from about 6 to about 8 or from about 6 to about 9, such as after precipitation of uranium salts, the dissolved uranium ions can form one or more complexes with a neutral, 1−, or 2− charge, such as one or more of UO₂CO₃, (UO₂)(CO₃)(OH)³⁻, UO₂(CO₃)₂²⁻UO₂SO₄, (UO₂)(SO₄)(OH)³⁻, and UO₂(SO₄)₂²⁻. Because sulfate and carbonate ions in the aqueous fluid can have a 2− charge, those ions compete with the uranium complexes for binding sites on the anion exchange material.

Increasing the pH of the aqueous fluid can cause the formation of one or more highly negatively charged complexes, for example, one or more of UO₂(CO₃)₃⁴⁻ and UO₂(SO₄)₃⁴⁻. Because both UO₂(CO₃)₃⁴⁻ and UO₂(SO₄)₃⁴⁻ are more highly charged than sulfate and carbonate, either of them can displace one or more of sulfate and carbonate, in addition to other anions with a 1− or 2− charge, from binding sites the anion exchange resin. This in turn can increase the efficiency of uranium removal from the aqueous fluid.

Removing one or more elements or one or more negative complexes of such elements from an aqueous fluid means reducing the amount or concentration of the one or more elements or one or more negative complexes in the aqueous fluid. The amount of the one or more elements remaining in the aqueous fluid after removal can be zero, incidental, undetectable, or trivial, however, this is not required unless otherwise specified. For example, the amount or concentration of the one or more elements or one or more negatively charged complexes can be reduced to about 5,000 μg/L or less, about 2,500 μg/L or less, about 1,000 μg/L or less, 500 μg/L or less, about 400 μg/L or less, about 300 μg/L or less, about 200 μg/L or less, about 100 μg/L or less, about 50 μg/L or less, about 30 μg/L or less, about 15 μg/L or less, about 6 μg/L or less, about 4 μg/L or less, or about 2 μg/L or less. Removing one or more elements or one or more negative complexes of such elements from an aqueous fluid can include reducing the concentration of such elements in the aqueous fluid to levels below regulatory thresholds.

In practice, removal of one or more elements or one or more negatively charged complexes from the aqueous fluid can reduced the concentration of the one or more elements or one or more negatively charged complexes to a concentration that depends on the nature of the one or more elements or one or more negatively charged complexes, the intended use of the aqueous fluid after their removal, and local rules or regulations regarding discharge of aqueous fluids. Thus, the uranium concentration in the aqueous fluid after removal of uranium or of one or more negatively charged complexes comprising uranium can be about 200 μg/L or less, such as about 100 μg/L or less or about 50 μg/L or less if the aqueous fluid is to be pumped back into the ground after extraction of uranium by in situ mining. However, if the aqueous liquid is to be used as drinking water, then the level of uranium can be reduced to about 50 μg/L or less, or about 30 μg/L or less. Similarly, reducing the concentration of the one or more elements can comprise one or more of one or more of reducing zinc concentration to about 5000 μg/L or less, reducing uranium concentration to about 50 μg/L or less, reducing thallium concentration to about 2 μg/L or less, reducing silver concentration to about 100 μg/L or less, reducing selenium concentration to about 500 μg/L or less, reducing inorganic mercury concentration to about 2 μg/L or less, reducing manganese concentration to about 50 μg/L or less, reducing lead concentration to about 15 μg/L or less, reducing iron concentration to about 300 μg/L or less, reducing copper concentration to about 100 μg/L or less, reducing chromium concentration to about 0.10 μg/L or less, reducing cadmium concentration to about 5 μg/L or less, reducing beryllium concentration to about 4 μg/L or less, reducing barium concentration to about 200 μg/L or less, reducing arsenic concentration to 10 μg/L or less, and reducing antimony concentration to about 6 μg/L or less.

After removal of one or more elements, the remaining aqueous fluid can be discharged to any suitable location. The suitable location will depend on the contents of the remaining aqueous fluid, the applicable regulations governing discharge of aqueous fluids, and the intended use of the remaining aqueous fluid. For example, the remaining aqueous fluid can be discharged to a suitable aquifer, for example, by using one or more mining injectors such as those discussed above with respect to in situ leaching. If appropriate, the remaining aqueous fluid can be discharged into a water system, such as a municipal waste water or drinking water system. As another example, if the remaining aqueous fluid is considered dangerous, for example, because it has unacceptably high radioactivity levels, then it can be discharged directly to an appropriate storage or decontamination facility or to appropriate containers for later transportation to an appropriate storage or decontamionation facility.

The process of the present invention can be carried out in a batch, semi-batch, or continuous mode. For example, in batch mode, a defined amount of aqueous fluid containing one or more elements to be removed, such as a settling pond or tank filled with the aqueous fluid can be treated, by one or more of electrolyzying and adding base to increase the pH, thereby forming negatively charged complexes of the one or more elements. The pH-adjusted aqueous fluid can then be contacted with one or more beds of one or more anion exchange materials, such as one or more anion exchange resin until sufficient amounts of the one or more elements are removed from the aqueous liquid (e.g. as an ionic complexes bound to the anion exchange resin). The remaining aqueous fluid can then be discharged in an appropriate manner.

Alternatively, in continuous mode, a stream of aqueous medium can be continuously pH-adjusted, by one or more of addition of base and electrolyzing to form a pH-adjusted aqueous fluid. The pH-adjusted aqueous fluid which can then be contacted passed through one or more beds of one or more anion exchange materials. The beds of anion exchange materials can be arranged, for example in series or in parallel, so that one or more individual beds of anion exchange material can be taken off-line for regeneration while the process is underway and the pH-adjusted aqueous fluid is treated in other beds of anion exchange material. Aqueous fluid can be continuously discharged after being passed through the one or more anion exchange materials.

In semi-batch mode, a defined amount of aqueous fluid can be treated continuously, although the process itself may be interrupted between treatment of individual batches of aqueous fluid.

### Example 1

Two samples of ground water having a pH of 7.3 and containing uranium were obtained from the same source. The first sample was passed through an anion exchange resin (DOWEX 21, a quaternary ammonium functionalized polystyrene crosslinked with divinyl benzene) without altering the pH. The resulting concentration of uranium was measured as a function of bed volumes of the ground water that passed through the anion exchange resin. The break through volume was determined as the number of bed volumes that passed through the anion exchange resin when the uranium concentration exceeded 50 μg/L. The results appear in Table 1.

TABLE 1
Uranium Concentration in pH 7.3 Unadjusted Groundwater

| Bed Volumes at pH 7.3 | Uranium concentration (μg/L) |
|---|---|
| 43 | 0.021 |
| 90 | 0 |
| 151 | 0.004 |
| 182 | 0.004 |
| 277 | 0.85 |
| 320 | 0.63 |
| 363 | 3.237 |
| 571 | 24.7 |
| 648 | 39.08 |
| 723 | 51.8 |

As shown in table 1, break through occurs at 723 bed volumes at pH 7.3.

The second sample of groundwater was electrolyzed to increase the pH to 10, and then passed through a DOWEX 21 anion exchange resin. The resulting concentration of uranium was measured as a function of bed volumes of water that had passed through the anion exchange resin. The results are shown in Table 2.

TABLE 2
Uranium Concentration in pH 10 Adjusted Groundwater

| Bed Volumes at pH 10 | Uranium concentration (μg/L) |
|---|---|
| 59 | 2.3 |
| 247 | 0.06 |
| 345 | 0.07 |
| 565 | 0.09 |
| 625 | 0.06 |
| 877 | 0.07 |
| 983 | 0 |
| 1137 | 0 |
| 1261 | 0 |
| 1439 | 0.09 |
| 2175 | 0 |
| 2271 | 0 |
| 2503 | 0 |
| 2719 | 0 |
| 3180 | 0 |
| 4783 | 0.2 |
| 5021 | 0.09 |
| 5231 | 0.05 |
| 5423 | 0.09 |
| 5567 | 0.1 |
| 5692 | 0.09 |
| 5892 | 0 |
| 6030 | 0 |
| 6162 | 0 |
| 6454 | 0 |
| 6646 | 0.12 |
| 6866 | 0.16 |
| 7040 | 0.12 |
| 7212 | 0.13 |
| 7424 | 0.25 |
| 7544 | 0.13 |
| 7704 | 0.34 |
| 7854 | 0.19 |
| 7962 | 0.22 |
| 8146 | 0.17 |
| 8344 | 0.58 |
| 8580 | 0.51 |
| 8768 | 1.3 |
| 9004 | 0.046 |
| 9084 | 1.21 |

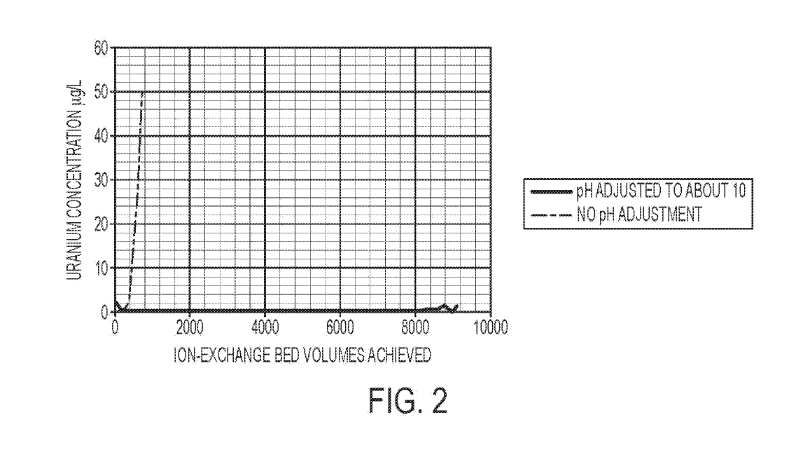

As shown in Table 2, adjusting the pH to about 10 dramatically and unexpectedly improves the efficiency of uranium removal. At this pH, over 9,000 bed volumes can be passed through the anion exchange resin without uranium break through. The data from Table 1 and Table 2 are compared in a graph in FIG. 2, which further illustrates the significant unexpected advantages of increasing the pH.

### Example 2

A sample of a ground from Example 1 and having a pH of 7.3 is placed in a mixing chamber, where lime is added to increase the pH to 10, and then passed through a DOWEX 21 anion exchange resin. The amount of uranium in the resulting aqueous fluid is measured as a function of the number of bed volumes that had passed through the anion exchange resin. The results are similar to those reported in Table 2.

1-42. (canceled)

43. A method of removing one or more elements from an aqueous fluid comprising:
increasing the pH of the aqueous fluid to about 9 or greater to form one or more negatively charged complexes comprising the one or more elements; and
contacting the aqueous fluid with one or more anion exchange materials to capture the one or more negatively charged complexes.

44. The method of claim 43, wherein the pH of the aqueous fluid is increased to about 10 or greater.

45. The method of claim 43, wherein increasing the pH of the aqueous fluid further comprises increasing the pH to from about 10 to about 11.

46. The method of claim 43, wherein increasing the pH of the aqueous fluid comprises contacting the aqueous fluid with a base.

47. The method of claim 44, wherein the base comprises one or more of a solid, a solution, and a suspension.

48. The method of claim 47, wherein the base comprises one or more of sodium hydroxide, potassium hydroxide, ammonium hydroxide, and magnesium hydroxide.

49. The method of claim 43, wherein increasing the pH of the aqueous fluid comprises electrolyzing the aqueous fluid.

50. The method of claim 49, wherein electrolyzing the aqueous fluid further comprises at least one of electrolyzing with one or more electrosorptive cathodes or electrolyzing with one or more electrosorptive anodes.

51. The method of claim 50, wherein electrolyzing the aqueous fluid further comprises electrolyzing with one or more porous, electrosorptive anodes and one or more non-porous, non electrosorptive cathodes.

52. The method of claim 50, wherein electrolyzing the aqueous fluid comprises electrolyzing at a voltage sufficient to electrolyze water in the aqueous fluid.

53. The method of claim 52, wherein electrolyzing the aqueous fluid comprises electrolyzing at a voltage of about 1.8 V or greater.

54. The method of claim 49, wherein electrolyzing the aqueous fluid further comprises producing one or more hydrogen or hydronium ions at the one or more porous, electrosorptive anodes.

55. The method of claim 54, further comprising forming one or more acids and immobilizing the one or more acids within the one or more electrosorptive anodes.

56. The method of claim 49, wherein electrolyzing the aqueous fluid comprises forming one or more hydroxide ions at the one or more non-porous, non-electrosorptive cathodes.

57. The method of claim 50, wherein the at least one non-porous, non-electrosorptive cathodes comprise one or more of stainless steel, iron, titanium, conductive carbon, copper, silver, gold, and platinum.

58. The method of claim 49, wherein electrolyzing the aqueous liquid further comprises electrolyzing with one or more porous, electrosorptive anodes;
wherein the porous electrosorptive anodes comprise:
one or more porous members;
one or more substrates;
one or more electrosorptive materials in the form of granules or powders disposed between the one or more porous members and one or more substrates; and
one or more means for retaining the one or more granules or powders between the one or more porous members and the one or more substrates.

59. The method of claim 58, wherein the one or more electrosorptive materials comprise one or more of conductive carbon materials, metal carbides, metals, and steels.

60. The method of claim 58, wherein the one or more electrosorptive materials comprise one or more of activated carbon, reticulated vitreous carbon, carbon aerogel, or pyrrolized resorcinol formaldehyde resin.

61. The method of claim 43 wherein the one or more anion exchange materials comprise one or more anion exchange polymers.

62. The method of claim 43 wherein the one or more anion exchange materials comprise one or more anion exchange polymers that are crosslinked with one or more crosslinkers.

63. The method of claim 62, wherein the one or more crosslinkers comprise divinyl benzene.

64. The method of claim 63, wherein the one or more anion exchange materials comprise polystyrene gel that is functionalized with quaternary ammonium functional groups and cross-linked with divinyl benzene.

65. The method of claim 43, wherein the aqueous fluid comprises one or more of water, groundwater, mine drainings, mine tailings, mine dumps, culm dumps, tails, slimes, refuses, leach residue, waste fluid from in situ mining, impregnated fluid from in situ mining, waste fluid from heap mining, impregnated fluid from heap mining, waste fluid from one or more nuclear facilities, municipal waste, and gangue-containing fluid.

66. The method of a claim 43, wherein the aqueous fluid comprises one or more of sulfate and carbonate.

67. The method of claim 43, wherein the aqueous fluid comprises about 100 mg/L sulfate or more.

68. The method of claim 43, wherein the aqueous fluid comprises about 100 mg/L carbonate or more.

69. The method of claim 43, wherein the aqueous fluid comprises from about 100 to about 2,000 mg/L sulfate.

70. The method of claim 43, wherein the aqueous fluid comprises from about 100 to about 2,000 mg/L carbonate

71. The method of claim 43, wherein the one or more elements comprise one or more of heavy metals, transition metals, lanthanides, actinides, alkali metals, as alkali metals with d electrons, alkaline earth metals, alkaline earth metals with d-electrons, rare earth metals, and semi-metals

72. The method of claim 43, wherein the one or more elements comprises one or more of antimony, arsenic, barium, beryllium, cadmium, chromium, copper, iron, lead, manganese, organic mercury, inorganic mercury, scandium, selenium, silver, thallium, uranium, zinc nickel, thorium, plutonium, neptunium, americium, and actinium.

73. The method of claim 43, wherein the one or more elements comprise uranium.

74. The method of claim 43, wherein the one or more negatively charged complexes comprise uranium.

75. The method of claim 43, wherein the one or more negatively charged complexes have a negative charge of 2 or greater.

76. The method of claim 75, wherein the one or more negatively charged complexes have a negative charge of 3 or greater.

77. The method of claim 76, wherein the one or more negatively charged complexes have a negative charge of 4 or greater.

78. The method of claim 43, wherein the one or more negatively charged complexes comprise one or more of UO₂(CO₃)₃⁴⁻ and UO₂(SO₄)₃⁴⁻.

79. The method of claim 43, wherein the one or more negatively charged complexes comprise UO₂(CO₃)₃⁴⁻.

80. The method of claim 43, wherein the one or more negatively charged complexes comprise UO₂(SO₄)₃⁴⁻.

81. The method of claim 43, wherein removing one or more elements from the aqueous fluid comprises reducing the concentration of the one or more elements to about 5,000 μg/L or less.

82. The method of claim 43, wherein removing one or more elements from the aqueous fluid comprises one or more of reducing zinc concentration to about 5000 μg/L or less, reducing uranium concentration to about 50 μg/L or less, reducing thallium concentration to about 2 μg/L or less, reducing silver concentration to about 100 μg/L or less, reducing selenium concentration to about 500 μg/L or less, reducing inorganic mercury concentration to about 2 μg/L or less, reducing manganese concentration to about 50 μg/L or less, reducing lead concentration to about 15 μg/L or less, reducing iron concentration to about 300 μg/L or less, reducing copper concentration to about 100 μg/L or less, reducing chromium concentration to about 0.10 μg/L or less, reducing cadmium concentration to about 5 μg/L or less, reducing beryllium concentration to about 4 μg/L or less, reducing barium concentration to about 200 μg/L or less, reducing arsenic concentration to 10 μg/L or less, and reducing antimony concentration to about 6 μg/L or less.

83. The method of claim 43, wherein removing one or more elements from the aqueous fluid comprises reducing the concentration of uranium to about 50 μg/L or less.

84. The method of claim 43, wherein removing one or more elements from the aqueous fluid comprises reducing the concentration of uranium to about 30 μg/L or less.
